(19) United States
(12) Patent Application Publication
(10) Pub. No.: US 2025/0120337 A1
(43) Pub. Date: Apr. 17, 2025

(54) WORK VEHICLE, INFORMATION PROCESSING DEVICE, CONTROL METHOD, AND NON-TRANSITORY COMPUTER-READABLE STORAGE MEDIUM

(71) Applicant: HONDA MOTOR CO., LTD., Tokyo (JP)

(72) Inventors: Kaito Takeuchi, Wako-shi (JP); Shota Tanabe, Wako-shi (JP); Toshinori Inagawa, Wako-shi (JP); Ai Habuka, Wako-shi (JP)

(21) Appl. No.: 18/907,992

(22) Filed: Oct. 7, 2024

Related U.S. Application Data
(60) Provisional application No. 63/590,087, filed on Oct. 13, 2023.

(51) Int. Cl. A01D 34/00; A01D 34/56

(52) U.S. Cl. CPC A01D 34/008; A01D 34/56

(57) ABSTRACT

A work vehicle, which includes drive wheels and blades serving as a working member, is equipped with a blade motor driver that controls rotation of the working member based on a target working member rotation state amount, and a drive wheel motor driver that controls movement of the work vehicle based on a target vehicle movement state amount, wherein the target working member rotation state amount and the target vehicle movement state amount are determined by a passenger or the like of the work vehicle, or alternatively, by a control device provided so as to be capable of communicating with the work vehicle.

### CROSS-REFERENCE TO RELATED APPLICATIONS

This application is based upon and claims the benefit of priority from U.S. Patent Application No. 63/590,087 filed on Oct. 13, 2023, the contents of which are incorporated herein by reference.

### BACKGROUND OF THE INVENTION

### Field of the Invention

The present disclosure relates to a work vehicle, an information processing device, a control method, and a non-transitory computer-readable storage medium.

### Description of the Related Art

A lawn mower is disclosed in JP 2020-162545 A. Such a lawn mower includes a lawn mowing device equipped with rotating blades.

### SUMMARY OF THE INVENTION

Recently, there has been a demand for a more satisfactory work vehicle such as a lawn mower or the like, a more satisfactory information processing device, a more satisfactory control method, and a more satisfactory non-transitory computer-readable storage medium.

A first aspect of the present invention is characterized by a work vehicle including vehicle wheels and a working member, the work vehicle comprising a first control unit configured to control rotation of the working member based on a target working member rotation state amount, and a second control unit configured to control movement of the work vehicle based on a target vehicle movement state amount, wherein the target working member rotation state amount is instructed by a passenger of the work vehicle, is instructed by an operator of the work vehicle, is instructed by a manager of the work vehicle, is determined by the work vehicle, or is determined by a control device that is provided so as to be communicable with the work vehicle, and the target vehicle movement state amount is instructed by the passenger, is instructed by the operator, is instructed by the manager, is determined by the work vehicle, or is determined by the control device.

A second aspect of the present invention is characterized by an information processing device configured to control a work vehicle including vehicle wheels and a working member, the information processing device comprising a first control unit configured to control rotation of the working member based on a target working member rotation state amount, and a second control unit configured to control movement of the work vehicle based on a target vehicle movement state amount, wherein the target working member rotation state amount is instructed by a passenger of the work vehicle, is instructed by an operator of the work vehicle, is instructed by a manager of the work vehicle, is determined by the work vehicle, or is determined by a control device that is provided so as to be communicable with the work vehicle, and the target vehicle movement state amount is instructed by the passenger, is instructed by the operator, is instructed by the manager, is determined by the work vehicle, or is determined by the control device.

A third aspect of the present invention is characterized by a control method for controlling a work vehicle including vehicle wheels and a working member, the control method comprising a step of controlling rotation of the working member based on a target working member rotation state amount, and a step of controlling movement of the work vehicle based on a target vehicle movement state amount, wherein the target working member rotation state amount is instructed by a passenger of the work vehicle, is instructed by an operator of the work vehicle, is instructed by a manager of the work vehicle, is determined by the work vehicle, or is determined by a control device that is provided so as to be communicable with the work vehicle, and the target vehicle movement state amount is instructed by the passenger, is instructed by the operator, is instructed by the manager, is determined by the work vehicle, or is determined by the control device.

A fourth aspect of the present disclosure is characterized by a non-transitory computer-readable storage medium, wherein the storage medium stores therein a program for causing a computer to execute the control method according to the third aspect.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a lawn mower;

FIG. 2 is a view of the lawn mower as seen from above;

FIG. 3 is a diagram for providing a description concerning teaching;

FIG. 4 is a load mode transition diagram;

FIG. 5 is a block diagram showing a configuration of a control device;

FIG. 6 is a diagram for providing a description concerning transitioning of load modes;

FIG. 7 is a diagram for providing a description concerning transitioning between a “normal mode” and a “low load mode” in accordance with an output of a blade motor;

FIG. 8 is a diagram for providing a description concerning transitioning between the “normal mode” and the “low load mode” in accordance with a vehicle speed of the lawn mower;

FIG. 9 is a diagram for providing a description concerning a rotational speed at a time of transitioning between the “normal mode” and the “low load mode”;

FIG. 10 is a diagram for providing a description concerning transitioning between the “normal mode” and a “medium load mode” in accordance with the output of the blade motor;

FIG. 11 is a diagram for providing a description concerning the vehicle speed of the lawn mower at a time of transitioning between the “normal mode” and the “medium load mode”;

FIG. 12 is a diagram for providing a description concerning transitioning between the “medium load mode” and a “high load mode” in accordance with the output of the blade motor;

FIG. 13 is a diagram for providing a description concerning the vehicle speed of the lawn mower at a time of transitioning between the “medium load mode” and the “high load mode”;

FIG. 14 is a diagram for providing a description concerning transitioning between the “normal mode”, the “medium load mode”, and the “high load mode” in accordance with the output of the blade motor;

FIG. 15 is a diagram for providing a description concerning the vehicle speed of the lawn mower at a time of transitioning between the “normal mode”, the “medium load mode”, and the “high load mode”;

FIG. 16 is a side view of a snow removal machine;

FIG. 17 is a side view of a hand-pushed type tilling machine; and

FIG. 18 is a side view of a riding type tilling machine.

### DETAILED DESCRIPTION OF THE INVENTION

It is desirable for an electric riding lawn mower to be capable of extending the time that the lawn can be mowed with a single battery charge, while leaving the grass in a satisfactory condition after mowing. Further, it is desirable for such an electric riding lawn mower to be capable of preventing stalling of a blade motor caused by clogging of grass therein. Furthermore, an improvement in marketability is desirable in relation to such an electric riding lawn mower. As one means for improving marketability, it is desirable to suppress variations in the rotational speed of the blades, fluctuations in vehicle behavior, and the like.

In the present disclosure, a description will be given concerning an electric riding lawn mower that is capable of achieving the aforementioned features. Moreover, it should be noted that the technology of the present disclosure is not limited to being applied to an electric riding lawn mower, but may also be applied to a lawn mower that is driven by an internal combustion engine, a lawn mower that is not intended to be ridden by a person, and the like. Further, the technology of the present disclosure is not limited to being applied to a lawn mower, but may also be applied to a snow removal machine or the like.

### Embodiment

A description will be given below concerning a lawn mower 10 according to the present embodiment. The lawn mower 10 corresponds to a work vehicle of the present invention.

### [Configuration of Lawn Mower]

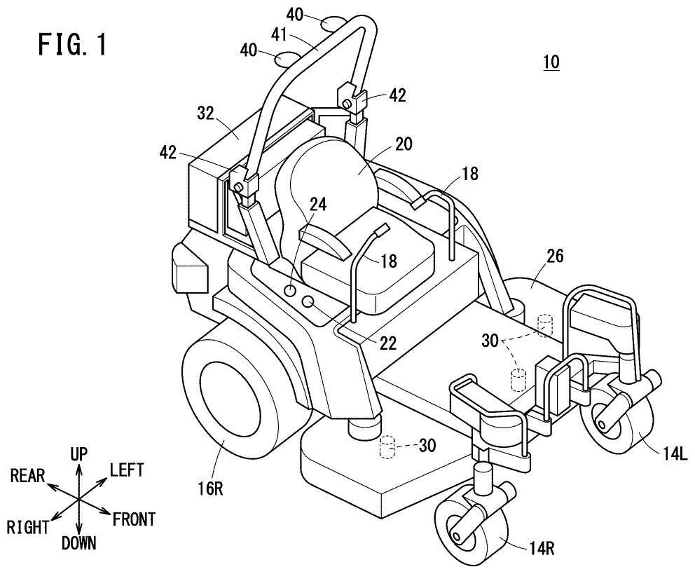

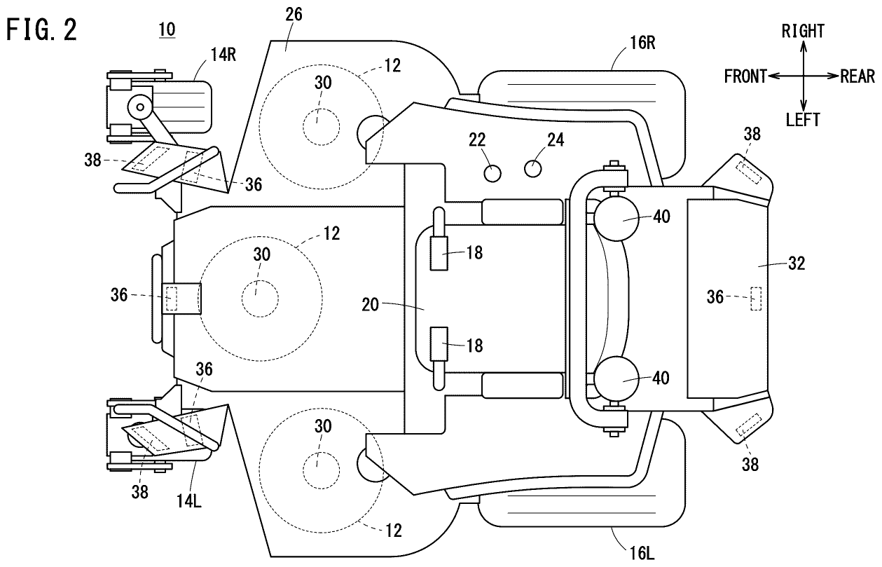

FIG. 1 is a perspective view of the lawn mower 10. FIG. 2 is a view of the lawn mower 10 as seen from above.

The lawn mower 10 of the present embodiment is an electric riding lawn mower. Stated otherwise, the lawn mower 10 according to the present embodiment travels by driving drive wheels by means of electric motors, and carries out a lawn mowing operation by blades 12 being caused to rotate by the electric motors. The dashed line circles representing the blades 12 in FIG. 2 indicate a rotational trajectory of outermost portions of the blades 12.

The lawn mower 10 of the present embodiment is capable of traveling and carrying out the lawn mowing operation based on operations of an operator who is riding on the lawn mower 10. The lawn mower 10 of the present embodiment is also capable of traveling and carrying out the lawn mowing operation based on operations performed by a manager who is not riding on the lawn mower 10 using a wireless transceiver or the like. The lawn mower 10 of the present embodiment is capable of automatically traveling and carrying out the lawn mowing operation without necessarily being operated by a driver, a manager, or the like. Hereinafter, carrying out of the traveling and the lawn mowing operation based on the operations of an operator or the like may be referred to as manual driving. Carrying out of the traveling and the lawn mowing operation automatically may also be referred to as automated driving.

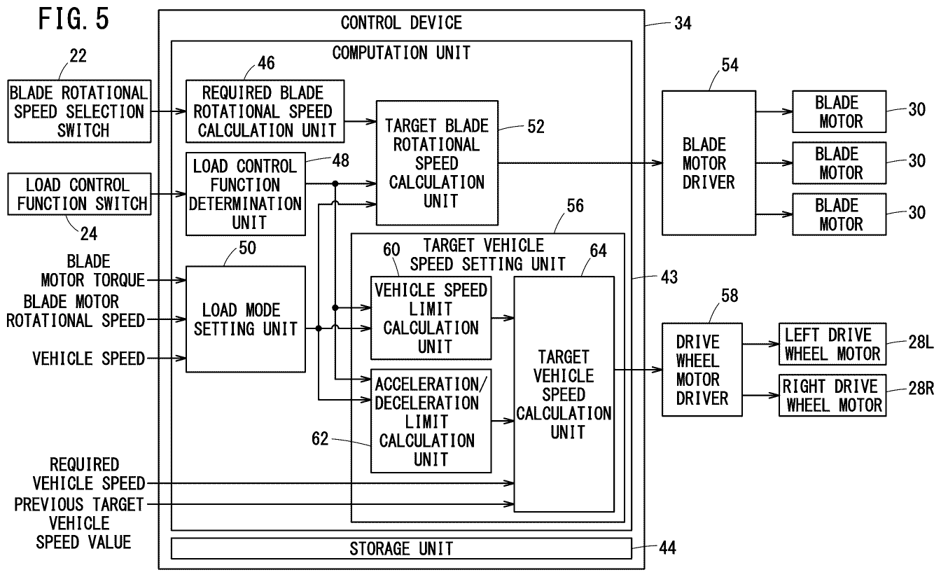

The lawn mower 10 is equipped with a left front wheel 14L, a right front wheel 14R, a left drive wheel 16L serving as a left rear wheel, and a right drive wheel 16R serving as a right rear wheel. The left front wheel 14L and the right front wheel 14R are caster wheels, and the direction thereof can be freely changed. The left drive wheel 16L is driven by a left drive wheel motor 28L (see FIG. 5), and the right drive wheel 16R is driven by a right drive wheel motor 28R (see FIG. 5). The lawn mower 10 does not have a steering wheel, and is capable of turning by means of a difference in the wheel speeds of the left drive wheel 16L and the right drive wheel 16R.

The lawn mower 10 is equipped with a pair of left and right operating levers 18, and a seat 20. The operator sits in the seat 20 and operates the operating levers 18. By the operating levers 18 being operated, the lawn mower 10 moves forward, moves rearward, and turns. In the present embodiment, the operator operates the lawn mower 10 by operating the operating levers 18 with the arms and hands of the operator's upper limbs, however, the operator may also operate the lawn mower 10 by operating pedals or the like with the legs and feet of the operator's lower limbs.

A blade rotational speed selection switch 22 and a load control function switch 24 are provided on the right side of the seat 20. A description will be given later concerning the blade rotational speed selection switch 22 and the load control function switch 24.

The lawn mower 10 is equipped with a work deck 26. The plurality of blades 12 are provided in the work deck 26. Mowing of the grass is carried out by the blades 12 rotating. Each of the blades 12 is driven by a blade motor 30 (see FIG. 5). The blades 12 correspond to a working member of the present invention. Since the blades 12 rotate, the blades 12 can also be referred to as rotating members. The blade motors 30 correspond to a drive source of the present invention.

A control box 32 is disposed rearwardly of the seat 20. The control box 32 accommodates a control device 34 (see FIG. 5) which will be described later.

The lawn mower 10 is equipped with various sensors that detect (recognize) a surrounding vicinity of the lawn mower 10. The various sensors are LiDAR sensors 36 and radar sensors 38. The LiDAR sensors 36 and the radar sensors 38 are distance measurement sensors that detect the surrounding vicinity of the lawn mower 10, by means of recognition mechanisms that differ from each other.

The LiDAR sensors 36, by emitting laser light around the vicinity of the lawn mower 10 and receiving reflected laser light from a work object and surrounding objects that exist in the surrounding vicinity of the lawn mower 10, detect (recognize) the distances and the directions to the work object and the surrounding objects, as well as the shapes of the work object and the surrounding objects. The work object, specifically, is a lawn or grass. The surrounding objects, for example, are obstacles that may become impediments to the operation of the lawn mower 10.

The radar sensors 38, by emitting radio waves such as millimeter waves or the like around the vicinity of the lawn mower 10 and receiving reflected waves of the radio waves from the work object and the surrounding objects that exist in the surrounding vicinity of the lawn mower 10, detect (recognize) the distances and the directions to the work object and the surrounding objects, as well as the shapes of the work object and the surrounding objects.

The lawn mower 10 of the present embodiment is equipped with four of the LiDAR sensors 36, and four of the radar sensors 38. The number of the LiDAR sensors 36, and in addition, the number of the radar sensors 38 need not necessarily be limited to four.

The lawn mower 10 is further equipped with two GNSS sensors 40. The two GNSS sensors 40 receive signals emitted from GNSS satellites. Based on the signals received by the two GNSS sensors 40, the lawn mower 10 is capable of determining its current position. The two GNSS sensors 40 are installed on a safety bar 41. The safety bar 41 is supported to be capable of rotating on two support members 42. In the case that the safety bar 41 is not used, the safety bar 41 can be inclined rearwardly.

### [Concerning Automated Driving]

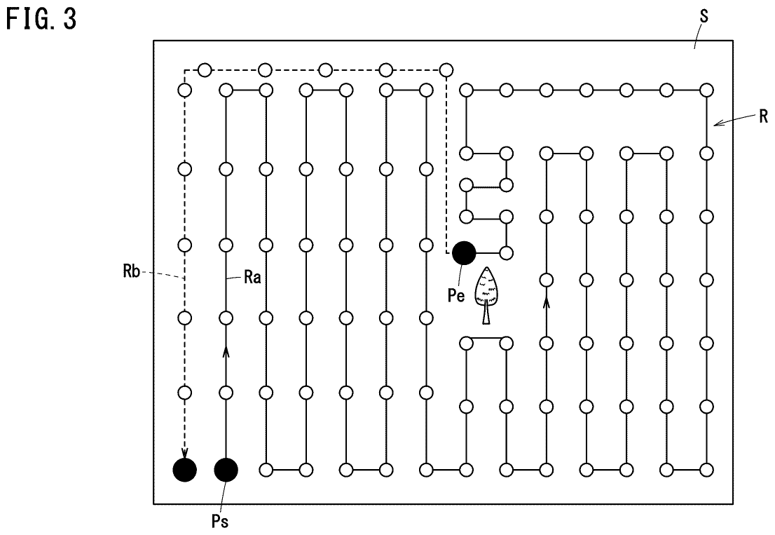

As noted previously, the lawn mower 10 of the present embodiment is capable of being driven automatically. In order to cause the lawn mower 10 to be driven automatically, teaching must be performed on the lawn mower 10 in advance. FIG. 3 is a diagram for providing a description concerning such teaching.

Teaching refers to an operation of causing the lawn mower 10, by an operation of the operator or the manager or the like, to travel in a region S in which the lawn mowing operation by the lawn mower 10 is carried out, and causing a travel route R to be stored in the lawn mower 10. While such teaching is being performed, a vehicle speed V and the like of the lawn mower 10 are recorded periodically. The recording of the vehicle speed V and the like may be carried out at each of predetermined intervals, or may be carried out at each of predetermined travel distances. Further, in such teaching, the operator, the manager, or the like causes the lawn mower 10 to carry out the lawn mowing operation and causes an operation start position Ps and an operation end position Pe to be stored in the lawn mower 10.

A travel route Ra shown by the solid lines in FIG. 3 indicates a route along which the lawn mower 10 travels while performing the lawn mowing operation, and a travel route Rb shown by the dashed lines in FIG. 3 indicates a route along which the lawn mower 10 travels without performing the lawn mowing operation.

At a time of automated driving, the lawn mower 10 performs a playback according to the information recorded by the teaching. During playback, the lawn mower 10 automatically travels along the travel route R that has been stored by way of the teaching in the lawn mower 10. Furthermore, during playback, the lawn mower 10 automatically performs the lawn mowing operation in an interval between the operation start position Ps and the operation end position Pe that have been stored by way of the teaching in the lawn mower 10.

As noted previously, the lawn mower 10 automatically travels and carries out the lawn mowing operation in accordance with the information recorded by way of the teaching. However, a load imposed on the lawn mower during the lawn mowing operation varies from day to day depending on the condition of the grass. For example, in a state in which the grass is relatively long, or in a state in which the grass is relatively densely packed, the load during the lawn mowing operation becomes high. Since the speed at which the grass grows, and the density of the grass are changed depending on factors such as the sunlight and the like, the speed and the density differ depending on the location within the area S.

The lawn mower 10 of the present embodiment switches the selection of the load mode depending on the load of the lawn mowing operation. According to the selected load mode, restrictions are imposed on a rotational speed B of the blades 12, and the vehicle speed V of the lawn mower 10.

### [Concerning Load Modes]

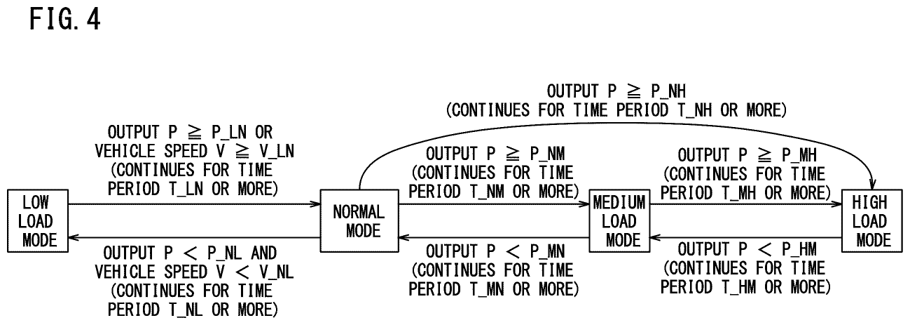

FIG. 4 is a load mode transition diagram. The lawn mower 10 has four load modes. The four load modes are a “normal mode”, a “low load mode”, a “medium load mode”, and a “high load mode”.

In the case that the load of the lawn mowing operation is in a normal state, the “normal mode” is selected. In the “normal mode”, restrictions are not imposed on the rotational speed B of the blades 12, and the vehicle speed V of the lawn mower 10. In the case that the load of the lawn mowing operation is in a low state, the “low load mode” is selected. In the “low load mode”, a restriction is imposed on the rotational speed B. In the “low load mode”, the area in which the lawn mower 10 is capable of performing the lawn mowing operation with a single charge is maximized.

In the case that the load of the lawn mowing operation is higher than normal, the “medium load mode” or the “high load mode” is selected. In the “low load mode”, a restriction is imposed on the rotational speed B of the blades 12, whereas in the “medium load mode” and the “high load mode”, a restriction is imposed on the vehicle speed V of the lawn mower 10.

In the case that the load of the lawn mowing operation is in a state that is somewhat higher than the normal state, the “medium load mode” is selected. In the “medium load mode”, a restriction is imposed on the vehicle speed V. In the case that the load of the lawn mowing operation is in a state that is significantly higher than the normal state, the “high load mode” is selected. In the “high load mode”, a stronger restriction is imposed on the vehicle speed V than in the “medium load mode”.

The rotational speed B of the blades 12 in the “medium load mode” and the “high load mode” is the same as the rotational speed B of the blades 12 in the “normal mode”. More specifically, the rotational speed B of the blades 12 in the “medium load mode” and the “high load mode” does not become higher than the rotational speed B of the blades 12 in the “normal mode”. In the “medium load mode” and in the “high load mode”, by restricting the vehicle speed V while keeping the rotational speed B constant, a situation is avoided in which the blade motors 30 become overloaded, and stalling of the blade motors 30 is suppressed.

Irrespective of whether the lawn mower 10 is being driven manually or is being driven automatically, restrictions in accordance with the load modes may be imposed on the rotational speed B and the vehicle speed V. Alternatively, only in a case in which the lawn mower 10 is being driven automatically, such restrictions in accordance with the load modes may be imposed on the rotational speed B and the vehicle speed V.

### [Configuration of Control Device]

FIG. 5 is a block diagram showing the configuration of the control device 34. The control device 34 is mounted in the lawn mower 10, and is connected to be capable of communicating with the lawn mower 10. The control device 34 corresponds to an information processing device of the present invention.

The control device 34 includes a computation unit 43 and a storage unit 44. The computation unit 43 is a processor such as, for example, a CPU (Central Processing Unit), a GPU (Graphics Processing Unit), or the like. The computation unit 43 includes a required blade rotational speed calculation unit 46, a load control function determination unit 48, a load mode setting unit 50, a target blade rotational speed calculation unit 52, and a target vehicle speed setting unit 56. The required blade rotational speed calculation unit 46, the load control function determination unit 48, the load mode setting unit 50, the target blade rotational speed calculation unit 52, and the target vehicle speed setting unit 56 are realized by a program that is stored in the storage unit 44 being executed in the computation unit 43. At least a portion of the required blade rotational speed calculation unit 46, the load control function determination unit 48, the load mode setting unit 50, the target blade rotational speed calculation unit 52, and the target vehicle speed setting unit 56 may be realized by an integrated circuit such as an ASIC (Application Specific Integrated Circuit), an FPGA (Field-Programmable Gate Array) or the like. At least a portion of the required blade rotational speed calculation unit 46, the load control function determination unit 48, the load mode setting unit 50, the target blade rotational speed calculation unit 52, and the target vehicle speed setting unit 56 may be realized by an electronic circuit including a discrete device.

The storage unit 44 is a non-transitory computer-readable tangible storage medium. The storage unit 44 is constituted by a non-illustrated volatile memory and a non-illustrated non-volatile memory. The volatile memory, for example, is a RAM (Random Access Memory) or the like. The non-volatile memory, for example, is a ROM (Read Only Memory), a flash memory, or the like. Data and the like are stored, for example, in the volatile memory. Programs, tables, maps, and the like are stored, for example, in the non-volatile memory. At least a portion of the storage unit 44 may be provided in the processor, the integrated circuit, or the like, which were discussed earlier. At least a portion of the storage unit 44 may be installed in a device that is connected by a network to the control device 34.

The required blade rotational speed calculation unit 46 calculates a required rotational speed of the blades 12. By the blade rotational speed selection switch 22 being operated, one from among a “high speed” and a “low speed” is selected as the rotational speed of the blades 12.

In the case that “high speed” is selected, the required blade rotational speed calculation unit 46 calculates a rotational speed B_H [rpm] as the required rotational speed of the blades 12. In the case that “low speed” is selected, the required blade rotational speed calculation unit 46 calculates a rotational speed B_L [rpm] as the required rotational speed of the blades 12. The rotational speed B_L [rpm] is lower than the rotational speed B_H [rpm].

The load control function determination unit 48 determines whether the load control function is “ON” or “OFF” based on the information input from the load control function switch 24. In the case that the load control function is “ON”, the load control function is operated. In the case that the load control function is “OFF”, the load control function is not operated.

The load mode setting unit 50 sets one of the aforementioned four load modes, based on the torque of the blade motors 30, the rotational speed B of the blade motors 30, and the vehicle speed V of the lawn mower 10. A description will be given later concerning the method for setting the load mode.

The target blade rotational speed calculation unit 52 calculates a target rotational speed of the blades 12. A blade motor driver 54 controls the blade motors 30 in a manner so that the rotational speed B of the blades 12 becomes the target rotational speed. The target blade rotational speed calculation unit 52 and the blade motor driver 54 correspond to a first control unit of the present invention. Further, the blade motor driver 54, together with the control device 34, constitutes the information processing device of the present invention.

In the case that the load control function is “OFF”, the target blade rotational speed calculation unit 52 calculates the required rotational speed of the blades 12 as the target rotational speed of the blades 12.

In the case that the load control function is “ON”, the target blade rotational speed calculation unit 52 calculates the target rotational speed in accordance with the load mode.

In the case that the load mode is the “normal mode”, the “medium load mode”, or the “high load mode”, the target blade rotational speed calculation unit 52 calculates the rotational speed B_H [rpm] as the target rotational speed of the blades 12. The blade motor driver 54 controls the blade motors 30 in a manner so that the rotational speed B of the blades 12 becomes the rotational speed B_H [rpm].

In the case that the load mode is the “low load mode”, the target blade rotational speed calculation unit 52 calculates the rotational speed B_L [rpm] as the target rotational speed of the blades 12. The blade motor driver 54 controls the blade motors 30 in a manner so that the rotational speed B of the blades 12 becomes the rotational speed B_L [rpm].

The target vehicle speed setting unit 56 sets a target vehicle speed. A drive wheel motor driver 58 controls the left drive wheel motor 28L and the right drive wheel motor 28R in a manner so that the vehicle speed V becomes the target vehicle speed. The target vehicle speed setting unit 56 and the drive wheel motor driver 58 correspond to a second control unit of the present invention. Further, the drive wheel motor driver 58, together with the control device 34, constitutes the information processing device of the present invention.

The target vehicle speed setting unit 56 includes a vehicle speed limit calculation unit 60, an acceleration/deceleration limit calculation unit 62, and a target vehicle speed calculation unit 64.

The vehicle speed limit calculation unit 60 calculates a vehicle speed limit. The vehicle speed limit is a value that defines a maximum value of the target vehicle speed that is calculated in the target vehicle speed calculation unit 64, which will be described later.

In the case that the load control function is “OFF”, the vehicle speed limit calculation unit 60 calculates a vehicle speed VLIM [Km/h] as the vehicle speed limit. In the case that the load control function is “ON”, the vehicle speed limit calculation unit 60 calculates the vehicle speed limit in accordance with the load mode.

In the case that the load mode is the “normal mode” or the “low load mode”, the vehicle speed limit calculation unit 60 calculates the vehicle speed VLIM [Km/h] as the vehicle speed limit. In the case that the load mode is the “medium load mode”, the vehicle speed limit calculation unit 60 calculates a vehicle speed VLIM_M [Km/h] as the vehicle speed limit. In the case that the load mode is the “high load mode”, the vehicle speed limit calculation unit 60 calculates a vehicle speed VLIM_H [Km/h] as the vehicle speed limit.

The vehicle speed limit VLIM [Km/h] is a speed that is higher than the vehicle speed limit VLIM_M [Km/h]. The vehicle speed limit VLIM_M [Km/h] is a speed that is higher than the vehicle speed limit VLIM_H [Km/h].

The acceleration/deceleration limit calculation unit 62 calculates an acceleration/deceleration limit. The acceleration/deceleration limit is a value that defines a maximum value of the amount of change of the target vehicle speed that is calculated in the target vehicle speed calculation unit 64, which will be described later.

In the case that the load control function is “OFF”, or alternatively, in the case that the load mode is the “low load mode”, the acceleration/deceleration limit is not calculated. In the case that the load mode is the “normal mode”, the acceleration/deceleration limit calculation unit 62 calculates an amount of change A_MN [G] as the acceleration/deceleration limit when transitioning from the “medium load mode” to the “normal mode”.

In the case that the load mode is the “medium load mode”, the acceleration/deceleration limit calculation unit 62 calculates an amount of change A_NM [G] as the acceleration/deceleration limit when transitioning from the “normal mode” to the “medium load mode”. Further, in the case that the load mode is the “medium load mode”, the acceleration/deceleration limit calculation unit 62 calculates an amount of change A_HM [G] as the acceleration/deceleration limit when transitioning from the “high load mode” to the “medium load mode”.

In the case that the load mode is the “high load mode”, the acceleration/deceleration limit calculation unit 62 calculates an amount of change A_MH [G] as the acceleration/deceleration limit when transitioning from the “medium load mode” to the “high load mode”. Further, in the case that the load mode is the “high load mode”, the acceleration/deceleration limit calculation unit 62 calculates an amount of change A_NH [G] as the acceleration/deceleration limit when transitioning from the “normal mode” to the “high load mode”.

The target vehicle speed calculation unit 64 calculates the target vehicle speed based on a required vehicle speed, a previous target vehicle speed value, the vehicle speed limit, and the acceleration/deceleration limit.

In the case of manual driving, the required vehicle speed is determined in accordance with an amount by which the operating levers 18 are operated by the operator or the like. In the case of automated driving, the vehicle speed V that was recorded at the time of teaching is set as the required vehicle speed.

The target vehicle speed calculation unit 64 repeatedly calculates the target vehicle speed at a predetermined cycle, and the previous target vehicle speed value is the target vehicle speed calculated in the previous cycle.

The target vehicle speed calculation unit 64 calculates, as the target vehicle speed, the lower value from among the required vehicle speed and the vehicle speed limit. Furthermore, in the case that the amount of change from the previous target vehicle speed value to the target vehicle speed is greater than or equal to the acceleration/deceleration limit, the target vehicle speed calculation unit 64 corrects the target vehicle speed in a manner so that the amount of change becomes the acceleration/deceleration limit. In the case that the amount of change from the previous target vehicle speed value to the target vehicle speed is smaller than the acceleration/deceleration limit, the target vehicle speed calculation unit 64 does not correct the target vehicle speed.

### [Concerning Transitioning of Load Modes]

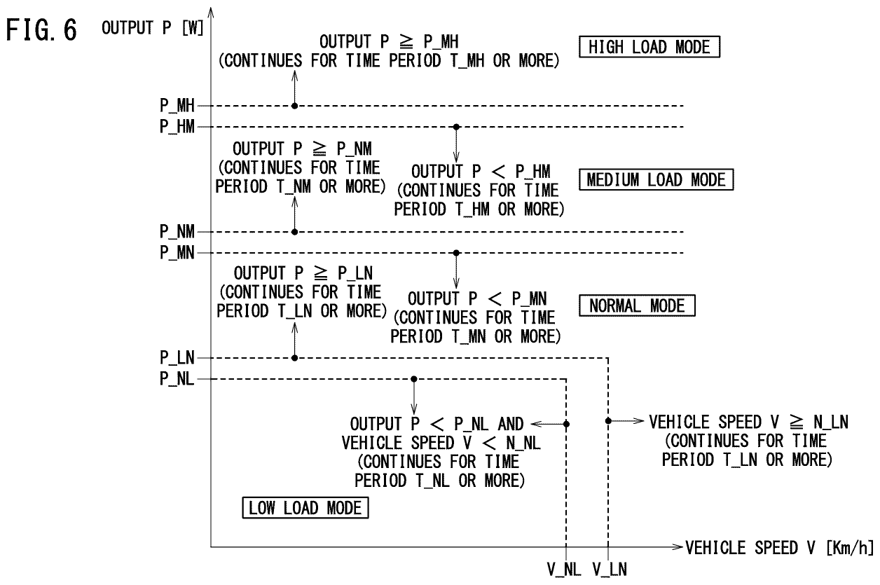

FIG. 6 is a diagram for providing a description concerning transitioning of the load modes. Hereinafter, based on FIG. 6 and the aforementioned FIG. 4, a description will be given concerning transitioning of the load modes.

The load mode is determined based on an output P of the blade motors 30 and the vehicle speed V of the lawn mower 10. The output P of the blade motors 30 is determined based on the rotational speed B and the torque of the blade motors 30. In the lawn mower 10 of the present embodiment, the rotational speed B of the blades 12 is controlled so as to become the rotational speed B_H [rpm] or the rotational speed B_L [rpm], and therefore, instead of the output P, the load mode may be determined based on the torque of the blade motors 30. Further, it goes without saying that the output P of the blade motors 30 may be calculated from the product of the applied voltage and the applied current of the blade motors 30 (voltage×current) or the like.

The output P of the blade motors 30 and the torque of the blade motors 30 correspond to an output correlation value of the present invention. The vehicle speed V of the lawn mower 10 corresponds to a movement state amount of the present invention.

When the load mode is the “normal mode”, in the case that the output P is less than a predetermined threshold value P_NL [W], and further, the vehicle speed V is less than a predetermined threshold value V_NL [Km/h], the load mode setting unit 50 sets the load mode to the “low load mode”. The threshold value P_NL [W] corresponds to a first threshold value of the present invention. The threshold value V_NL [Km/h] corresponds to a fifth threshold value of the present invention.

Alternatively to the above-described condition, when the load mode is the “normal mode”, in the case that the output P is less than the threshold value P_NL [W], or the vehicle speed V is less than the threshold value V_NL [Km/h], the load mode setting unit 50 may set the load mode to the “low load mode”.

When the load mode is the “low load mode”, in the case that the output P is greater than or equal to a predetermined threshold value P_LN [W], or the vehicle speed V is greater than or equal to a predetermined threshold value V_LN [Km/h], the load mode setting unit 50 sets the load mode to the “normal mode”. The threshold value P_LN [W] corresponds to a third threshold value of the present invention. The threshold value V_LN [Km/h] corresponds to a seventh threshold value of the present invention.

When the load mode is the “normal mode”, in the case that the output P is greater than or equal to a predetermined threshold value P_NM [W], the load mode setting unit 50 sets the load mode to the “medium load mode”. The threshold value P_NM [W] corresponds to a ninth threshold value of the present invention.

When the load mode is the “medium load mode”, in the case that the output P is less than a predetermined threshold value P_MN [W], the load mode setting unit 50 sets the load mode to the “normal mode”. The threshold value P_MN [W] corresponds to an eleventh threshold value of the present invention.

When the load mode is the “medium load mode”, in the case that the output P is greater than or equal to a predetermined threshold value P_MH [W], the load mode setting unit 50 sets the load mode to the “high load mode”. The threshold value P_MH [W] corresponds to a thirteenth threshold value of the present invention.

When the load mode is the “high load mode”, in the case that the output P is less than a predetermined threshold value P_HM [W], the load mode setting unit 50 sets the load mode to the “medium load mode”. The threshold value P_HM [W] corresponds to a fifteenth threshold value of the present invention.

When the load mode is the “normal mode”, in the case that the output P is greater than or equal to a predetermined threshold value P_NH [W], the load mode setting unit 50 sets the load mode to the “high load mode” (see FIG. 4). The threshold value P_NH [W] corresponds to a seventeenth threshold value of the present invention.

As shown in FIG. 4, in the case that the load of the lawn mowing operation rapidly becomes higher, a transition may take place from the “normal mode” to the “high load mode” while skipping over the “medium load mode”. On the other hand, even in the case that the load of the lawn mowing operation rapidly becomes lower, the “medium load mode” will not be skipped over, and a transition will not take place from the “high load mode” to the “normal mode”.

Next, a description will be given in detail concerning transitioning between two of the load modes.

### (Transitioning Between “Normal Mode” and “Medium Load Mode”)

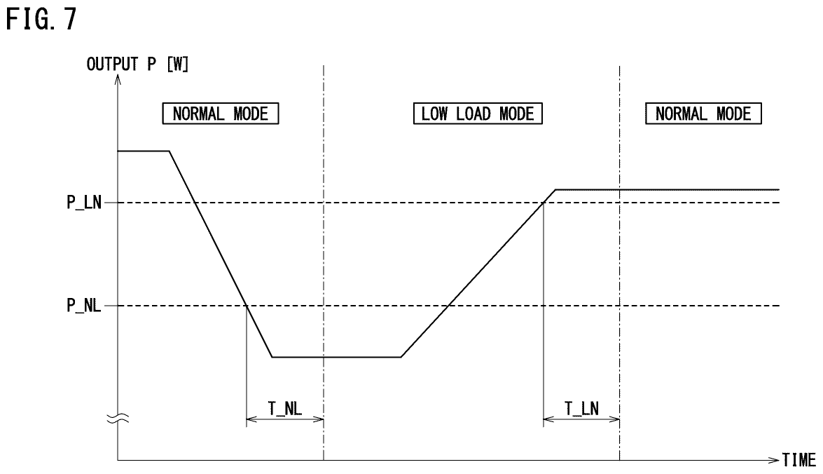

FIG. 7 is a diagram for providing a description concerning transitioning between the “normal mode” and the “low load mode” in accordance with the output P of the blade motors 30. In this instance, a description will be given concerning transitioning between the “normal mode” and the “low load mode” taking as an assumption that the vehicle speed V of the lawn mower 10 is less than the threshold value V_NL [Km/h].

When the load mode is the “normal mode”, in the case that the output P has become less than the threshold value P_NL [W] for a predetermined threshold time period T_NL or more, the load mode transitions from the “normal mode” to the “low load mode”. The threshold time period T_NL corresponds to a second threshold time period of the present invention. When the load mode is the “normal mode”, in the case it is predicted that the output P will become less than the threshold value P_NL [W], the load mode may transition from the “normal mode” to the “low load mode”.

When the load mode is the “low load mode”, in the case that the output P has become greater than or equal to the threshold value P_LN [W] for a predetermined threshold time period T_LN or more, the load mode transitions from the “low load mode” to the “normal mode”. The threshold time period T_LN corresponds to a fourth threshold time period of the present invention. When the load mode is the “low load mode”, in the case it is predicted that the output P will become greater than or equal to the threshold value P_LN [W], the load mode may transition from the “low load mode” to the “normal mode”.

The threshold value P_LN [W] is set to an output that is higher than the threshold value P_NL [W]. Further, the threshold time period T_NL and the threshold time period T_LN are set as waiting times from a point in time at which the transition condition is satisfied. In accordance with this feature, it is possible to suppress the occurrence of frequent transitioning between the “normal mode” and the “low load mode”.

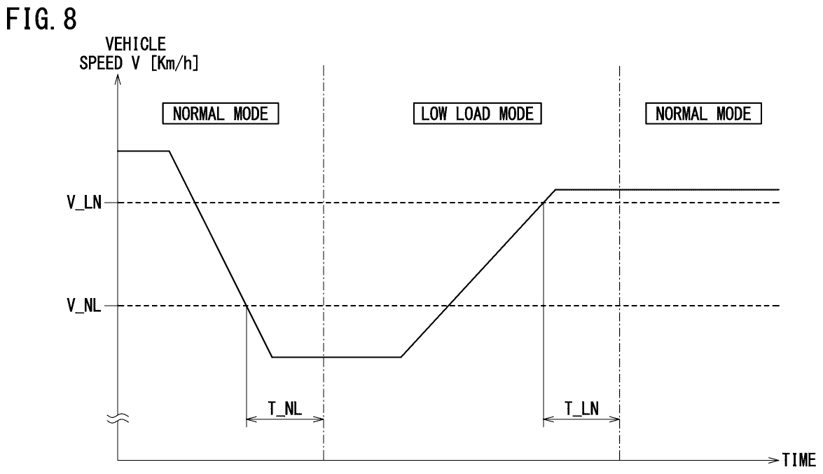

FIG. 8 is a diagram for providing a description concerning transitioning between the “normal mode” and the “low load mode” in accordance with the vehicle speed V of the lawn mower 10. In this instance, a description will be given concerning transitioning between the “normal mode” and the “low load mode” taking as an assumption that the output P of the blade motors 30 is less than the threshold value P_NL [W].

When the load mode is the “normal mode”, in the case that the vehicle speed V has become less than the threshold value V_NL [Km/h] for a threshold time period T_NL or more, the load mode transitions from the “normal mode” to the “low load mode”. The threshold time period T_NL corresponds to a sixth threshold time period of the present invention. When the load mode is the “normal mode”, in the case it is predicted that the vehicle speed V will become less than the threshold value V_NL [Km/h], the load mode may transition from the “normal mode” to the “low load mode”.

When the load mode is the “low load mode”, in the case that the vehicle speed V has become greater than or equal to the threshold value V_LN [Km/h] for a predetermined threshold time period T_LN or more, the load mode transitions from the “low load mode” to the “normal mode”. The threshold time period T_LN corresponds to an eighth threshold time period of the present invention. When the load mode is the “low load mode”, in the case it is predicted that the vehicle speed V will become greater than or equal to the threshold value V_LN [Km/h], the load mode may transition from the “low load mode” to the “normal mode”.

The threshold value V_LN [Km/h] is set to a vehicle speed that is higher than the threshold value V_NL [Km/h]. Further, the threshold time period T_NL and the threshold time period T_LN are set as waiting times from a point in time at which the transition condition is satisfied. In accordance with this feature, it is possible to suppress the occurrence of frequent transitioning between the “normal mode” and the “low load mode”.

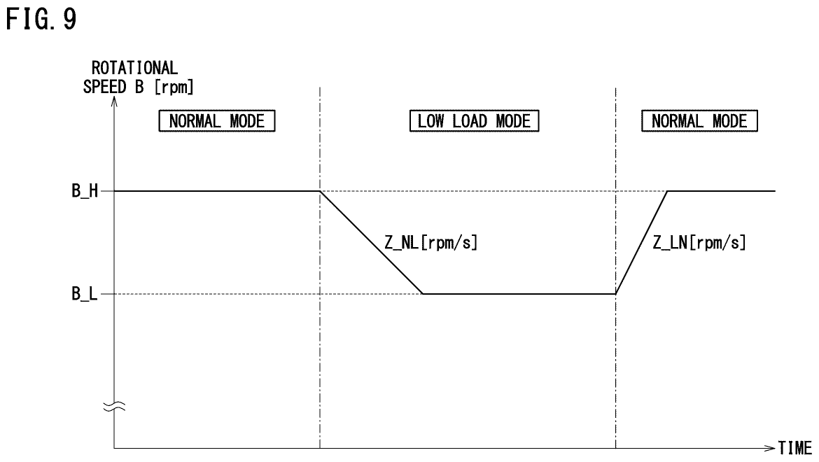

FIG. 9 is a diagram for providing a description concerning the rotational speed B of the blades 12 at a time of transitioning between the “normal mode” and the “low load mode”.

In the case that the load mode is the “normal mode”, the target blade rotational speed calculation unit 52 calculates the rotational speed B_H [rpm] as the target rotational speed, and the blade motor driver 54 controls the rotational speed B so as to become the target rotational speed B_H [rpm]. The control of the rotational speed B of the blades 12 based on the target rotational speed B_H [rpm] corresponds to a first working member control mode of the present invention. The target rotational speed B_H [rpm] corresponds to a target working member rotation state amount of the present invention.

In the case that the load mode is the “low load mode”, the target blade rotational speed calculation unit 52 calculates the rotational speed B_L [rpm] of the blades 12 as the target rotational speed, and the blade motor driver 54 controls the rotational speed B of the blades 12 so as to become the target rotational speed B_L [rpm]. The control of the rotational speed B of the blades 12 based on the target rotational speed B_L [rpm] corresponds to a second working member control mode of the present invention. The target rotational speed B_L [rpm] corresponds to a reduced target working member rotation state amount of the present invention.

In the case of having transitioned from the “normal mode” to the “low load mode”, the rotational speed of the blades 12 decreases from the rotational speed B_H [rpm] to the rotational speed B_L [rpm]. In this case, the target blade rotational speed calculation unit 52 calculates the target rotational speed in a manner so that the amount of change of the target rotational speed of the blades 12 becomes Z_NL [rpm/s]. The blade motor driver 54 controls the blade motors 30 based on the target rotational speed that has been calculated in this manner, whereby the amount of change of the rotational speed B of the blades 12 becomes the Z_NL [rpm/s]. The amount of change Z_NL [rpm/s] corresponds to a first amount of change of the present invention.

In the case of having transitioned from the “low load mode” to the “normal mode”, the rotational speed B of the blades 12 changes from the rotational speed B_L [rpm] to the rotational speed B_H [rpm]. In this case, the target blade rotational speed calculation unit 52 calculates the target rotational speed in a manner so that the amount of change of the target rotational speed of the blades 12 becomes Z_LN [rpm/s]. The blade motor driver 54 controls the blade motors 30 based on the target rotational speed that has been calculated in this manner, whereby the amount of change of the rotational speed B of the blades 12 becomes the Z_LN [rpm/s]. The amount of change Z_LN [rpm/s] corresponds to a second amount of change of the present invention.

The magnitude of the amount of change Z_LN [rpm/s] is greater than the magnitude of the amount of change Z_NL [rpm/s]. By slowly reducing the rotational speed B, it is possible to suppress a sudden change in the sound that is generated by the rotation of the blades 12, and to prevent people in the surrounding vicinity of the lawn mower 10 from feeling a sense of discomfort. Further, by quickly increasing the rotational speed B, the efficiency of the lawn mowing operation can be improved.

### (Transitioning Between “Normal Mode” and “Medium Load Mode”)

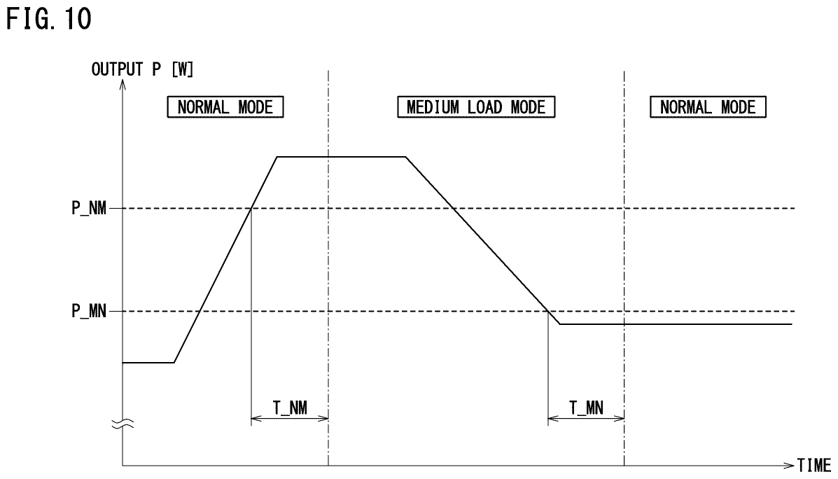

FIG. 10 is a diagram for providing a description concerning transitioning between the “normal mode” and the “medium load mode” in accordance with the output P of the blade motors 30.

When the load mode is the “normal mode”, in the case that the output P has become greater than or equal to the threshold value P_NM [W] for a predetermined threshold time period T_NM or more, the load mode transitions from the “normal mode” to the “medium load mode”. The threshold time period T_NM corresponds to a tenth threshold time period of the present invention. When the load mode is the “normal mode”, in the case it is predicted that the output P will become greater than or equal to the threshold value P_NM [W], the load mode may transition from the “normal mode” to the “medium load mode”.

When the load mode is the “medium load mode”, in the case that the output P has become less than or equal to the threshold value P_MN [W] for a predetermined threshold time period T_MN or more, the load mode transitions from the “medium load mode” to the “normal mode”. The threshold time period T_MN corresponds to a twelfth threshold time period of the present invention. When the load mode is the “medium load mode”, in the case it is predicted that the output P will become less than the threshold value P_MN [W], the load mode may transition from the “medium load mode” to the “normal mode”.

The threshold value P_NM [W] is set to an output that is higher than the threshold value P_MN [W]. Further, the threshold time period T_NM and the threshold time period T_MN are set as waiting times from a point in time at which the transition condition is satisfied. In accordance with this feature, it is possible to suppress the occurrence of frequent transitioning between the “normal mode” and the “medium load mode”.

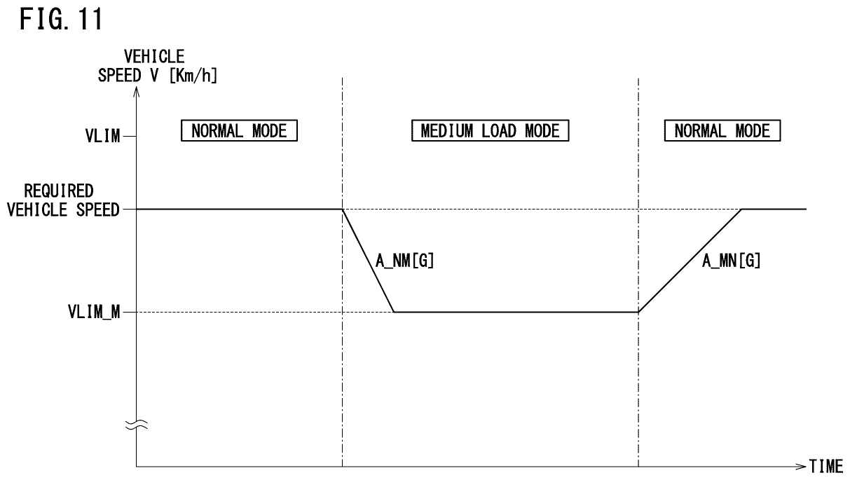

FIG. 11 is a diagram for providing a description concerning the vehicle speed V of the lawn mower 10 at a time of transitioning between the “normal mode” and the “medium load mode”.

In the case that the load mode is the “normal mode”, the target vehicle speed calculation unit 64 calculates, as the target vehicle speed, the lower value from among the required vehicle speed and the vehicle speed limit VLIM, and the drive wheel motor driver 58 controls the vehicle speed V so as to become the target vehicle speed. The control of the vehicle speed V in which the lower value from among the required vehicle speed and the vehicle speed limit VLIM is set as the target vehicle speed corresponds to a first movement control mode of the present invention. The target vehicle speed, which is set to the lower value from among the required vehicle speed and the vehicle speed limit VLIM, corresponds to a target vehicle movement state amount of the present invention.

In the case that the load mode is the “medium load mode”, the lower value from among the required vehicle speed and the vehicle speed limit VLIM_M is calculated as the target vehicle speed, and the drive wheel motor driver 58 controls the vehicle speed V so as to become the target vehicle speed. The control of the vehicle speed V in which the lower value from among the required vehicle speed and the vehicle speed limit VLIM_M is set as the target vehicle speed corresponds to a second movement control mode of the present invention. The target vehicle speed, which is set to the lower value from among the required vehicle speed and the vehicle speed limit VLIM_M, corresponds to a first reduced target vehicle movement state amount of the present invention.

In the case that the required vehicle speed is higher than the vehicle speed limit VLIM_M, then when the mode has transitioned from the “normal mode” to the “medium load mode”, the vehicle speed V of the lawn mower 10 decreases. In this case, the target vehicle speed calculation unit 64 corrects the target vehicle speed in a manner so that the amount of change of the target vehicle speed of the lawn mower 10 becomes the amount of change A_NM [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_NM [G]. The amount of change A_NM [G] corresponds to a third amount of change of the present invention.

In the case that the required vehicle speed is higher than the vehicle speed limit VLIM_M, then when the mode has transitioned from the “medium load mode” to the “normal mode”, the vehicle speed V of the lawn mower 10 increases. In this case, the target vehicle speed calculation unit 64 corrects the target vehicle speed in a manner so that the amount of change of the target vehicle speed of the lawn mower 10 becomes the amount of change A_MN [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_MN [G]. The amount of change A_MN [G] corresponds to a fourth amount of change of the present invention.

The magnitude of the amount of change A_NM [G] is greater than the magnitude of the amount of change A_MN [G]. By quickly reducing the vehicle speed V, the load of the lawn mowing operation can be reduced, and stalling of the blade motors 30 can be suppressed. Further, by slowly increasing the vehicle speed V, a sudden acceleration of the lawn mower 10 can be suppressed.

### (Transitioning Between “Medium Load Mode” and “High Load Mode”)

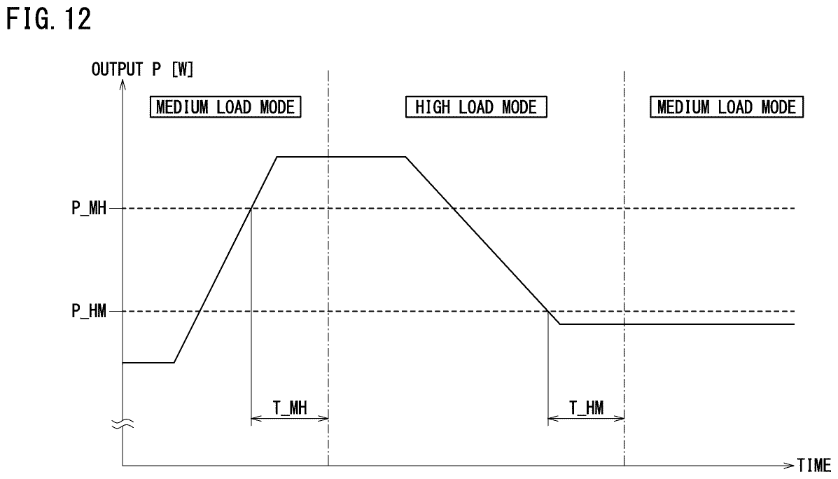

FIG. 12 is a diagram for providing a description concerning transitioning between the “medium load mode” and the “high load mode” in accordance with the output P of the blade motors 30.

When the load mode is the “medium load mode”, in the case that the output P has become greater than or equal to the threshold value P_MH [W] for a predetermined threshold time period T_MH or more, the load mode transitions from the “medium load mode” to the “high load mode”. The threshold time period T_MH corresponds to a fourteenth threshold time period of the present invention. When the load mode is the “medium load mode”, in the case it is predicted that the output P will become greater than or equal to the threshold value P_MH [W], the load mode may transition from the “medium load mode” to the “high load mode”.

When the load mode is the “high load mode”, in the case that the output P has become less than the threshold value P_HM [W] for a predetermined threshold time period T_HM or more, the load mode transitions from the “high load mode” to the “medium load mode”. The threshold time period T_HM corresponds to a sixteenth threshold time period of the present invention. When the load mode is the “high load mode”, in the case it is predicted that the output P will become less than the threshold value P_HM [W], the load mode may transition from the “high load mode” to the “medium load mode”.

The threshold value P_MH [W] is set to an output that is higher than the threshold value P_HM [W]. Further, the threshold time period T_MH and the threshold time period T_HM are set as waiting times from a point in time at which the transition condition is satisfied. In accordance with this feature, it is possible to suppress the occurrence of frequent transitioning between the “medium load mode” and the “high load mode”.

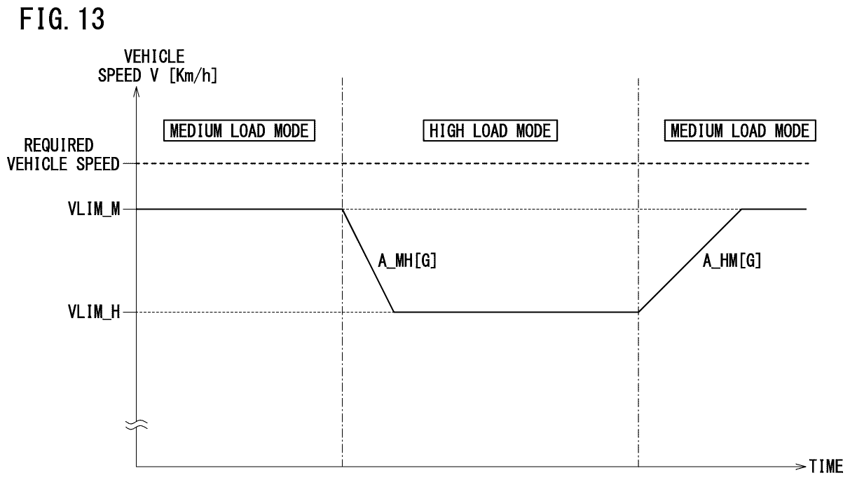

FIG. 13 is a diagram for providing a description concerning the vehicle speed V of the lawn mower 10 at a time of transitioning between the “medium load mode” and the “high load mode”.

In the case that the load mode is the “medium load mode”, the target vehicle speed calculation unit 64 calculates, as the target vehicle speed, the lower value from among the required vehicle speed and the vehicle speed limit VLIM_M, and the drive wheel motor driver 58 controls the vehicle speed V so as to become the target vehicle speed.

In the case that the load mode is the “high load mode”, the lower value from among the required vehicle speed and the vehicle speed limit VLIM_H is calculated as the target vehicle speed, and the drive wheel motor driver 58 controls the vehicle speed V so as to become the target vehicle speed. The control of the vehicle speed V in which the lower value from among the required vehicle speed and the vehicle speed limit VLIM_H is set as the target vehicle speed corresponds to a third movement control mode of the present invention. The target vehicle speed, which is set to the lower value from among the required vehicle speed and the vehicle speed limit VLIM_H, corresponds to a second reduced target vehicle movement state amount of the present invention.

In the case that the required vehicle speed is higher than the vehicle speed limit VLIM_H, then when the mode has transitioned from the “medium load mode” to the “high load mode”, the vehicle speed V of the lawn mower 10 decreases. In this case, the target vehicle speed calculation unit 64 corrects the target vehicle speed in a manner so that the amount of change of the target vehicle speed of the lawn mower 10 becomes the amount of change A_MH [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_MH [G].

In the case that the required vehicle speed is higher than the vehicle speed limit VLIM_H, then when the mode has transitioned from the “high load mode” to the “medium load mode”, the vehicle speed V of the lawn mower 10 increases. In this case, the target vehicle speed calculation unit 64 corrects the target vehicle speed in a manner so that the amount of change of the target vehicle speed of the lawn mower 10 becomes the amount of change A_HM [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_HM [G].

The magnitude of the amount of change A_MH [G] is greater than the magnitude of the amount of change A_HM [G]. By quickly reducing the vehicle speed V, the load of the lawn mowing operation can be reduced, and stalling of the blade motors 30 can be suppressed. Further, by slowly increasing the vehicle speed V, a sudden acceleration of the lawn mower 10 can be suppressed.

### (Transitioning Between “Normal Mode”, “Medium Load Mode”, and “High Load Mode”)

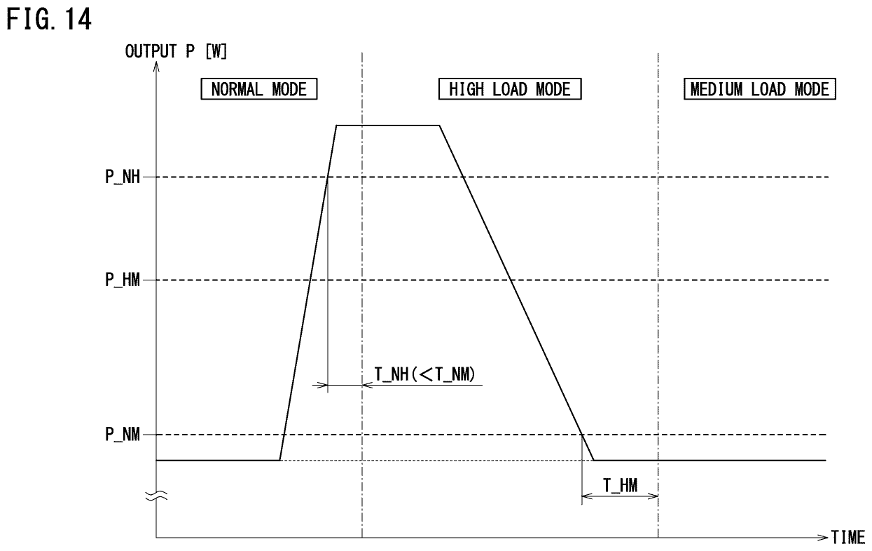

FIG. 14 is a diagram for providing a description concerning transitioning between the “normal mode”, the “medium load mode”, and the “high load mode” in accordance with the output P of the blade motors 30.

When the load mode is the “normal mode”, in the case that the output P has become greater than or equal to the threshold value P_NH [W] for a predetermined threshold time period T_NH or more, the load mode transitions from the “normal mode” to the “high load mode”. When the load mode is the “normal mode”, in the case it is predicted that the output P will become greater than or equal to the threshold value P_NH [W], the load mode may transition from the “normal mode” to the “high load mode”.

When the load mode is the “high load mode”, in the case that the output P has become less than the threshold value P_HM [W] for a predetermined threshold time period T_HM or more, the load mode transitions from the “high load mode” to the “medium load mode”. When the load mode is the “high load mode”, in the case it is predicted that the output P will become less than the threshold value P_HM [W], the load mode may transition from the “high load mode” to the “medium load mode”.

The threshold time period T_NH is set to a time period that is shorter than the aforementioned threshold time period T_NM. In accordance with this feature, in the case that the load of the lawn mowing operation has suddenly increased when the load mode is the “normal mode”, it is possible to directly transition to the “high load mode” in which a stronger restriction is imposed on the vehicle speed V than in the “medium load mode”. Thus, the load of the lawn mowing operation is made lower, and stalling of the blade motors 30 can be suppressed.

On the other hand, when the load mode is the “high load mode”, even in the case that the load of the lawn mowing operation has suddenly decreased and the output P has become lower than the threshold value P_NM as shown in FIG. 14, transitioning does not take place from the “high load mode” directly to the “normal mode”. Thus, an increase in the load of the lawn mowing operation caused by an increase in the vehicle speed V can be made gentler, and stalling of the blade motors 30 can be suppressed.

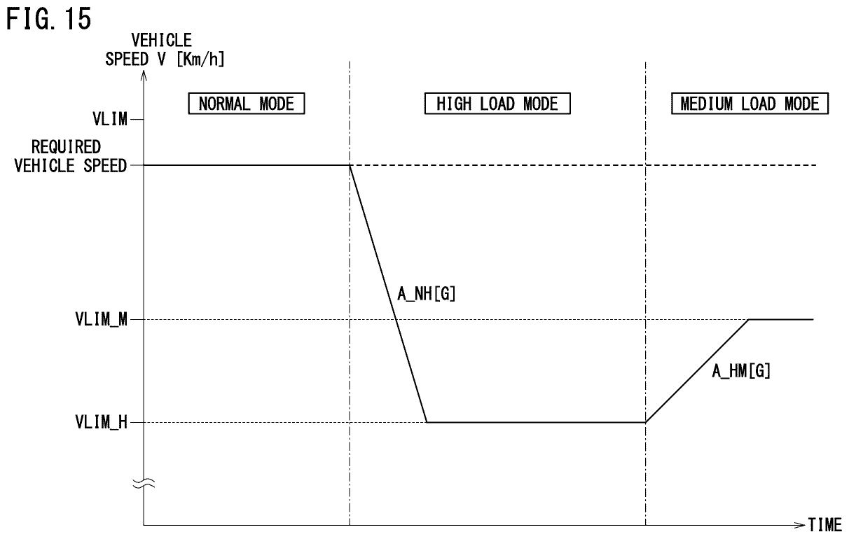

FIG. 15 is a diagram for providing a description concerning the vehicle speed V of the lawn mower 10 at a time of transitioning between the “normal mode”, the “medium load mode”, and the “high load mode”.

In the case that the load mode is the “normal mode”, the target vehicle speed calculation unit 64 calculates, as the target vehicle speed, the lower value from among the required vehicle speed and the vehicle speed limit VLIM, and the drive wheel motor driver 58 controls the vehicle speed V so as to become the target vehicle speed.

In the case that the load mode is the “high load mode”, the lower value from among the required vehicle speed and the vehicle speed limit VLIM_H is calculated as the target vehicle speed, and the drive wheel motor driver 58 controls the vehicle speed V so as to become the target vehicle speed.

In the case that the load mode is the “medium load mode”, the lower value from among the required vehicle speed and the vehicle speed limit VLIM_M is calculated as the target vehicle speed, and the drive wheel motor driver 58 controls the vehicle speed V so as to become the target vehicle speed.

In the case that the required vehicle speed is higher than the vehicle speed limit VLIM_H, then when the mode has transitioned from the “normal mode” to the “high load mode”, the vehicle speed V of the lawn mower 10 decreases. In this case, the target vehicle speed calculation unit 64 corrects the target vehicle speed in a manner so that the amount of change of the target vehicle speed of the lawn mower 10 becomes the amount of change A_NH [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_NH [G].

In the case that the required vehicle speed is higher than the vehicle speed limit VLIM_H, then when the mode has transitioned from the “high load mode” to the “medium load mode”, the vehicle speed V of the lawn mower 10 increases. In this case, the target vehicle speed calculation unit 64 corrects the target vehicle speed in a manner so that the amount of change of the target vehicle speed of the lawn mower 10 becomes the amount of change A_HM [G]. The drive wheel motor driver 58 controls the left drive wheel motor 28L and the right drive wheel motor 28R based on the target vehicle speed that has been calculated in this manner, whereby the amount of change of the vehicle speed V of the lawn mower 10 becomes the amount of change A_HM [G].

The magnitude of the amount of change A_NH [G] is greater than the magnitude of the amount of change A_HM [G]. By quickly reducing the vehicle speed V, the load of the lawn mowing operation can be reduced, and stalling of the blade motors 30 can be suppressed. Further, by slowly increasing the vehicle speed V, a sudden acceleration of the lawn mower 10 can be suppressed.

### [Configuration of Snow Removal Machine]

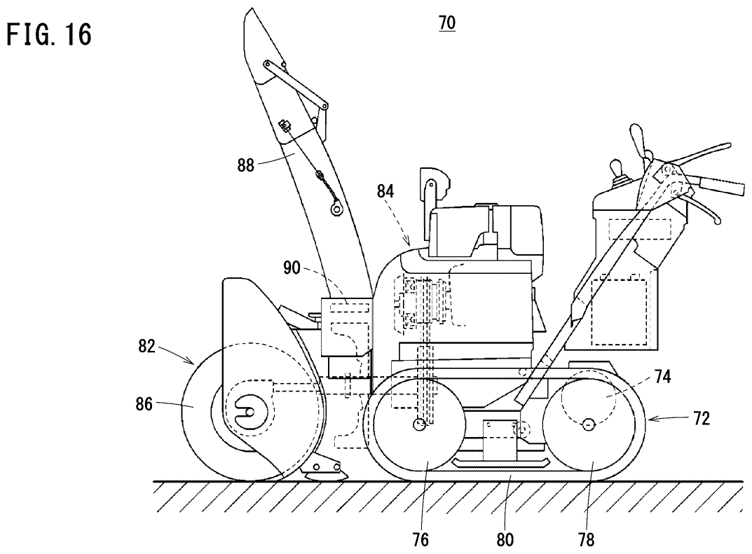

The technology of the present disclosure may also be applied to a snow removal machine 70. FIG. 16 is a side view of the snow removal machine 70. The snow removal machine 70 corresponds to the work vehicle of the present invention.

The snow removal machine 70 is equipped with a traveling unit 72 for causing the snow removal machine 70 to travel, and a traveling drive unit 74 that drives the traveling unit 72. The traveling unit 72 includes driven wheels 76, drive wheels 78, and roller belts 80. The roller belts 80 are each wrapped around the driven wheel 76 and the drive wheel 78. The traveling drive unit 74 drives the drive wheels 78. The drive wheels 78 correspond to vehicle wheels of the present invention.

The snow removal machine 70 is equipped with a snow removal unit 82 for carrying out removal of snow, and a snow removal drive unit 84 that drives the snow removal unit 82. The snow removal unit 82 is provided at a front end part of the snow removal machine 70. The snow removal unit 82 includes an auger 86. The auger 86 is provided to be capable of rotating. The snow removal drive unit 84 drives the auger 86. The auger 86 corresponds to the working member of the present invention. The snow removal drive unit 84 corresponds to the drive source of the present invention.

The snow removal machine 70 is equipped with a chute 88 through which the snow removed by the snow removal unit 82 is thrown, and a chute drive unit 90 that drives the chute 88. By the chute 88 being driven by the chute drive unit 90, the direction in which the chute 88 throws the snow can be changed.

In the above-described lawn mower 10, the load of the lawn mowing operation varies depending on the growth state of the grass, the density of the grass, and the like. In the snow removal machine 70, the load of a snow removal operation varies depending on the state of the accumulated snow. For example, in the case of accumulated snow caused by wet snow in which moisture is plentiful, the weight of the snow per unit volume becomes heavier than in the case of accumulated snow caused by dry powdery snow, and the load of the snow removal operation becomes greater. In addition, as the amount of the accumulated snow becomes greater, since a lower layer portion of the accumulated snow is compressed by the weight of an upper layer portion of the snow, the load of the snow removal operation becomes greater. Further, in the case that a comparatively long period of time has passed from the snow having been accumulated, since the surface of the accumulated snow freezes and becomes in the form of porous crystals, the load of the snow removal operation becomes greater.

By applying the technology of the present disclosure to the snow removal machine 70, the condition of a road surface or the like after the snow removal operation can be improved. The snow removal machine 70 is capable of suppressing stalling of the auger 86 due to becoming clogged with snow. Furthermore, the snow removal machine 70 is capable of suppressing variations in the rotational speed of the auger 86, variations in the vehicle behavior, and the like.

### [Configuration of Tilling Machine]

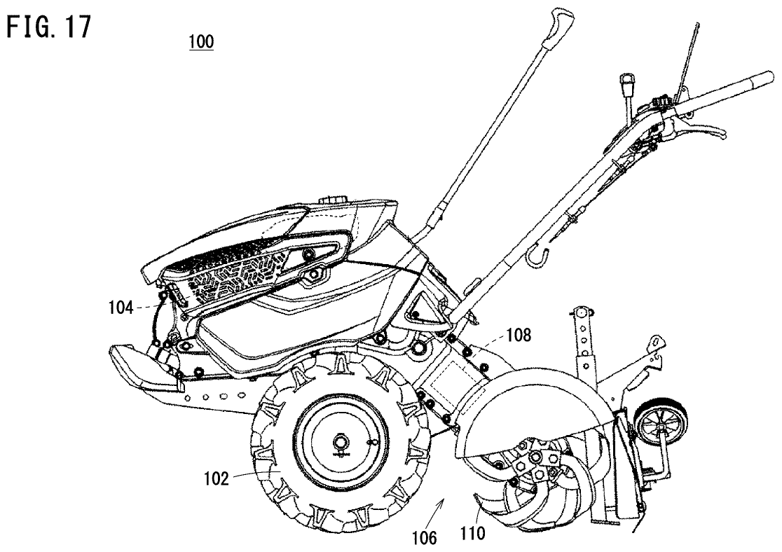

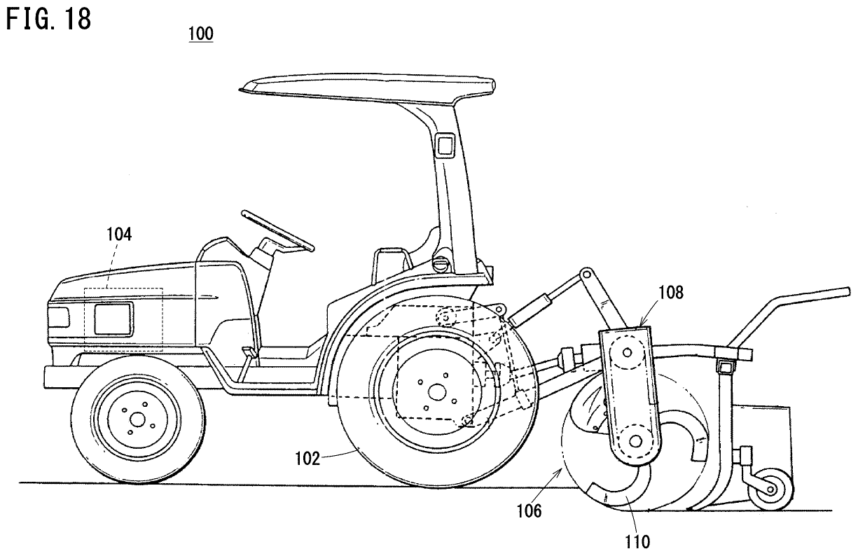

The technology of the present disclosure may also be applied to a tilling machine 100. FIG. 17 is a side view of a hand-pushed type tilling machine 100. FIG. 18 is a side view of a riding type tilling machine 100.

The tilling machine 100 is equipped with drive wheels 102 for causing the tilling machine 100 to travel, and a traveling drive unit 104 that drives the drive wheels 102. The traveling drive unit 104 drives the drive wheels 102. The drive wheels 102 correspond to the vehicle wheels of the present invention.

The tilling machine 100 is equipped with a tilling unit 106 that tills the soil, and a tilling drive unit 108 that drives the tilling unit 106. The tilling unit 106 is provided at a rear end part of the tilling machine 100. The tilling unit 106 includes tilling tines 110. The tilling tines 110 are provided to be capable of rotating. The tilling drive unit 108 drives the tilling tines 110. The tilling tines 110 correspond to the working member of the present invention. The tilling drive unit 108 corresponds to the drive source of the present invention.

In the above-described lawn mower 10, the load of the lawn mowing operation varies depending on the growth state of the grass, the density of the grass, and the like. In the tilling machine 100, the load of a tilling operation varies depending on the condition of the soil. For example, in the case that the soil is clay, the weight of the soil per unit volume becomes heavier than in the case that the soil is sandy, and the load of the tilling operation becomes greater. Further, as plant roots that remain within the soil are more plentiful, the load of the tilling operation becomes greater.

By applying the technology of the present disclosure to the tilling machine 100, the condition of the soil after the tilling operation can be improved. The tilling machine 100 is capable of suppressing stalling of the tilling tines 110 due to becoming clogged with soil. Furthermore, the tilling machine 100 is capable of suppressing variations in the rotational speed of the tilling tines 110, variations in the vehicle behavior, and the like.

The following supplementary notes are further disclosed in relation to the above-described embodiment.

### Supplementary Note 1

Provided is the work vehicle (10, 70, 100) including the vehicle wheels (16L, 16R, 78, 102) and the working member (12), the work vehicle comprising the first control unit (52, 54) that controls the rotation of the working member based on the target working member rotation state amount, and the second control unit (56, 58) that controls the movement of the work vehicle based on the target vehicle movement state amount, wherein the target working member rotation state amount is instructed by the passenger of the work vehicle, is instructed by the operator of the work vehicle, is instructed by the manager of the work vehicle, is determined by the work vehicle, or is determined by the control device (34) that is provided to be capable of communicating with the work vehicle, and the target vehicle movement state amount is instructed by the passenger, is instructed by the operator, is instructed by the manager, is determined by the work vehicle, or is determined by the control device. In accordance with such features, it is possible to provide a more satisfactory work vehicle.

### Supplementary Note 2

In the work vehicle according to Supplementary Note 1, a control mode in which the rotation of the working member is controlled by the first control unit may include the first working member control mode of controlling the rotation of the working member based on the target working member rotation state amount, and the second working member control mode of controlling the rotation of the working member based on the reduced target working member rotation state amount that is smaller than the target working member rotation state amount, and during the first working member control mode, in the case that the output correlation value in the working member, or the output correlation value in the drive source (30) that drives the working member has become less than a predetermined first threshold value, the first control unit may transition from the first working member control mode to the second working member control mode. In accordance with such features, in the case that the work load has become smaller than the normal load, the rotation of the working member is controlled based on the reduced target working member rotation state amount, and therefore, the energy efficiency of the work vehicle can be improved.

### Supplementary Note 3

In the work vehicle according to Supplementary Note 2, during the first working member control mode, in the case that the output correlation value has become less than the first threshold value for a predetermined second threshold time period or more, the first control unit may transition from the first working member control mode to the second working member control mode. In accordance with this feature, it is possible to suppress the occurrence of frequent transitioning between the first working member control mode and the second working member control mode.

### Supplementary Note 4

In the work vehicle according to Supplementary Note 2, during the second working member control mode, in the case that the output correlation value has become greater than or equal to a predetermined third threshold value that differs from the first threshold value, the first control unit may transition from the second working member control mode to the first working member control mode. In accordance with this feature, in the case that the work load has returned to the normal load, the rotation of the working member is controlled based on the target working member rotation state amount, and therefore, the operational efficiency can be improved.

### Supplementary Note 5

In the work vehicle according to Supplementary Note 4, during the second working member control mode, in the case that the output correlation value has become greater than or equal to the third threshold value for a predetermined fourth threshold time period or more, the first control unit may transition from the second working member control mode to the first working member control mode. In accordance with this feature, it is possible to suppress the occurrence of frequent transitioning between the first working member control mode and the second working member control mode.

### Supplementary Note 6

In the work vehicle according to Supplementary Note 1, a control mode in which the rotation of the working member is controlled by the first control unit may include the first working member control mode of controlling the rotation of the working member based on the target working member rotation state amount, and the second working member control mode of controlling the rotation of the working member based on the reduced target working member rotation state amount that is smaller than the target working member rotation state amount, and during the first working member control mode, in the case that the movement state amount of the work vehicle has become less than a predetermined fifth threshold value, the first control unit may transition from the first working member control mode to the second working member control mode. In accordance with such features, in the case that the work load has become smaller than the normal load, the rotation of the working member is controlled based on the reduced target working member rotation state amount, and therefore, the energy efficiency of the work vehicle can be improved.

### Supplementary Note 7

In the work vehicle according to Supplementary Note 6, during the first working member control mode, in the case that the movement state amount has become less than the fifth threshold value for a predetermined sixth threshold time period or more, the first control unit may transition from the first working member control mode to the second working member control mode. In accordance with this feature, it is possible to suppress the occurrence of frequent transitioning between the first working member control mode and the second working member control mode.

### Supplementary Note 8

In the work vehicle according to Supplementary Note 6, during the second working member control mode, in the case that the movement state amount has become greater than or equal to a predetermined seventh threshold value that differs from the fifth threshold value, the first control unit may transition from the second working member control mode to the first working member control mode. In accordance with this feature, in the case that the work load has returned to the normal load, the rotation of the working member is controlled based on the target working member rotation state amount, and therefore, the operational efficiency can be improved.

### Supplementary Note 9

In the work vehicle according to Supplementary Note 8, during the second working member control mode, in the case that the movement state amount has become greater than or equal to the seventh threshold value for a predetermined eighth threshold time period or more, the first control unit may transition from the second working member control mode to the first working member control mode. In accordance with this feature, it is possible to suppress the occurrence of frequent transitioning between the first working member control mode and the second working member control mode.

### Supplementary Note 10

In the work vehicle according to Supplementary Note 2, when transitioning from the first working member control mode to the second working member control mode, the first control unit may control the rotation of the working member in a manner so that a change occurs, by the first amount of change, from the target working member rotation state amount to the reduced target working member rotation state amount. In accordance with this feature, it is possible to suppress a sudden change from the target working member rotation state amount to the reduced target working member rotation state amount.

### Supplementary Note 11

In the work vehicle according to Supplementary Note 10, when transitioning from the second working member control mode to the first working member control mode, the first control unit may control the rotation of the working member in a manner so that a change occurs, by the second amount of change that differs from the first amount of change, from the reduced target working member rotation state amount to the target working member rotation state amount. In accordance with this feature, it is possible to suppress a sudden change from the reduced target working member rotation state amount to the target working member rotation state amount.

### Supplementary Note 12

In the work vehicle according to Supplementary Note 11, the magnitude of the second amount of change may be greater than the magnitude of the first amount of change. In accordance with this feature, it is possible to slowly reduce the working member rotation state amount, to suppress a sudden change in the rotation state of the working member, and to prevent the user from feeling a sense of discomfort. Further, by quickly increasing the working member rotation state amount, the operational efficiency can be improved.

### Supplementary Note 13

In the work vehicle according to Supplementary Note 1, a control mode in which the movement of the work vehicle is controlled by the second control unit may include the first movement control mode of controlling the movement of the work vehicle based on the target vehicle movement state amount, and the second movement control mode of controlling the movement of the work vehicle based on the first reduced target vehicle movement state amount that is smaller than the target vehicle movement state amount, and during the first movement control mode, in the case that the output correlation value in the working member, or the output correlation value in the drive source that drives the working member has become greater than or equal to a predetermined ninth threshold value, the second control unit may transition from the first movement control mode to the second movement control mode. In accordance with such features, in the case that the work load has become somewhat greater than the normal load, the movement of the work vehicle is controlled based on the first reduced target vehicle movement state amount, and therefore, the work load can be reduced.

### Supplementary Note 14

In the work vehicle according to Supplementary Note 13, during the first movement control mode, in the case that the output correlation value has become greater than or equal to the ninth threshold value for a predetermined tenth threshold time period or more, the second control unit may transition from the first movement control mode to the second movement control mode. In accordance with this feature, it is possible to suppress the occurrence of frequent transitioning between the first movement control mode and the second movement control mode.

### Supplementary Note 15

In the work vehicle according to Supplementary Note 14, during the second movement control mode, in the case that the output correlation value has become less than a predetermined eleventh threshold value that differs from the ninth threshold value, the second control unit may transition from the second movement control mode to the first movement control mode. In accordance with this feature, in the case that the work load has returned to the normal load, the movement of the work vehicle is controlled based on the target vehicle movement state amount, and therefore, the operational efficiency can be improved.

### Supplementary Note 16

In the work vehicle according to Supplementary Note 15, during the second movement control mode, in the case that the output correlation value has become less than the eleventh threshold value for a predetermined twelfth threshold time period or more, the second control unit may transition from the second movement control mode to the first movement control mode. In accordance with this feature, it is possible to suppress the occurrence of frequent transitioning between the first movement control mode and the second movement control mode.

### Supplementary Note 17

In the work vehicle according to Supplementary Note 13, a control mode in which the movement of the work vehicle is controlled by the second control unit may further include the third movement control mode of controlling the movement of the work vehicle based on the second reduced target vehicle movement state amount that is smaller than the first reduced target vehicle movement state amount, and during the second movement control mode, in the case that the output correlation value has become greater than or equal to a predetermined thirteenth threshold value that is greater than the ninth threshold value, the second control unit may transition from the second movement control mode to the third movement control mode. In accordance with such features, in the case that the work load has become significantly greater than the normal load, the movement of the work vehicle is controlled based on the second reduced target vehicle movement state amount, and therefore, the work load can be further reduced.

### Supplementary Note 18

In the work vehicle according to Supplementary Note 17, during the second movement control mode, in the case that the output correlation value has become greater than or equal to the thirteenth threshold value for a predetermined fourteenth threshold time period or more, the second control unit may transition from the second movement control mode to the third movement control mode. In accordance with this feature, it is possible to suppress the occurrence of frequent transitioning between the second movement control mode and the third movement control mode.

### Supplementary Note 19

In the work vehicle according to Supplementary Note 17, during the third movement control mode, in the case that the output correlation value has become less than a predetermined fifteenth threshold value that differs from the thirteenth threshold value, the second control unit may transition from the third movement control mode to the second movement control mode. In accordance with this feature, in the case that the work load has decreased, the movement of the work vehicle is controlled based on the first reduced target vehicle movement state amount, and therefore, the operational efficiency can be improved.

### Supplementary Note 20

In the work vehicle according to Supplementary Note 19, during the third movement control mode, in the case that the output correlation value has become less than the fifteenth threshold value for a predetermined sixteenth threshold time period or more, the second control unit may transition from the third movement control mode to the second movement control mode. In accordance with this feature, it is possible to suppress the occurrence of frequent transitioning between the second movement control mode and the third movement control mode.

### Supplementary Note 21

In the work vehicle according to Supplementary Note 13, a control mode in which the movement of the work vehicle is controlled by the second control unit may further include the third movement control mode of controlling the movement of the work vehicle based on the second reduced target vehicle movement state amount that is smaller than the first reduced target vehicle movement state amount, and during the first movement control mode, in the case that the output correlation value has become greater than or equal to a predetermined seventeenth threshold value that is greater than the ninth threshold value, the second control unit may transition from the first movement control mode to the third movement control mode. In accordance with such features, in the case that the workload has suddenly become greater, the mode transitions directly from the first movement control mode to the third movement control mode. Since the movement of the work vehicle is controlled based on the second reduced target vehicle movement state amount, the work load can be rapidly reduced.

### Supplementary Note 22

In the work vehicle according to Supplementary Note 21, during the third movement control mode, in the case that the output correlation value has become less than a predetermined fifteenth threshold value for a predetermined sixteenth threshold time period or more, the second control unit may transition from the third movement control mode to the second movement control mode. In accordance with this feature, even in the case that the work load has suddenly become smaller, the mode transitions directly from the third movement control mode to the second movement control mode without transitioning directly from the third movement control mode to the first movement control mode. Since the movement of the work vehicle is controlled based on the second reduced target vehicle movement state amount, a sudden change of the work load can be suppressed.

### Supplementary Note 23

In the work vehicle according to Supplementary Note 13, when transitioning from the first movement control mode to the second movement control mode, the second control unit may control the movement of the work vehicle in a manner so that a change occurs, by the third amount of change, from the target vehicle movement state amount to the first reduced target vehicle movement state amount. In accordance with this feature, it is possible to suppress a sudden change from the target vehicle movement state amount to the first reduced target vehicle movement state amount.

### Supplementary Note 24

In the work vehicle according to Supplementary Note 23, when transitioning from the second movement control mode to the first movement control mode, the second control unit may control the movement of the work vehicle in a manner so that a change occurs, by the fourth amount of change that differs from the third amount of change, from the first reduced target vehicle movement state amount to the target vehicle movement state amount. In accordance with this feature, it is possible to suppress a sudden change from the first reduced target vehicle movement state amount to the target vehicle movement state amount.

### Supplementary Note 25

In the work vehicle according to Supplementary Note 24, the magnitude of the third amount of change may be greater than the magnitude of the fourth amount of change. In accordance with this feature, by quickly reducing the vehicle movement state amount, the work load can be quickly reduced. Further, by slowly increasing the vehicle movement state amount, a sudden acceleration of the work vehicle can be suppressed.

### Supplementary Note 26

Provided is the information processing device (34) that controls the work vehicle including the vehicle wheels and the working member, the information processing device comprising the first control unit that controls the rotation of the working member based on the target working member rotation state amount, and the second control unit that controls the movement of the work vehicle based on the target vehicle movement state amount, wherein the target working member rotation state amount is instructed by the passenger of the work vehicle, is instructed by the operator of the work vehicle, is instructed by the manager of the work vehicle, is determined by the work vehicle, or is determined by the control device that is provided to be capable of communicating with the work vehicle, and the target vehicle movement state amount is instructed by the passenger, is instructed by the operator, is instructed by the manager, is determined by the work vehicle, or is determined by the control device. In accordance with such features, it is possible to provide a more satisfactory information processing device.

### Supplementary Note 27

Provided is the control method for controlling the work vehicle including the vehicle wheels and the working member, the control method comprising the step of controlling the rotation of the working member based on the target working member rotation state amount, and the step of controlling the movement of the work vehicle based on the target vehicle movement state amount, wherein the target working member rotation state amount is instructed by the passenger of the work vehicle, is instructed by the operator of the work vehicle, is instructed by the manager of the work vehicle, is determined by the work vehicle, or is determined by the control device that is provided to be capable of communicating with the work vehicle, and the target vehicle movement state amount is instructed by the passenger, is instructed by the operator, is instructed by the manager, is determined by the work vehicle, or is determined by the control device. In accordance with such features, it is possible to provide a more satisfactory control method.

### Supplementary Note 28

Provided is the non-transitory computer-readable storage medium (44), wherein the storage medium stores therein the program for causing the computer to execute the control method according to Supplementary Note 27. In accordance with this feature, it is possible to provide a storage medium in which there is stored a program that is capable of executing a more satisfactory control method.

Although a description has been given in detail concerning the present disclosure, it is not intended that the present disclosure be limited to each of the embodiments described above. Various additions, substitutions, changes, partial deletions, or the like can be made to such embodiments within a range that does not depart from the essence and gist of the present disclosure, or within a range that does not depart from the essence and gist of the present disclosure as derived from the content described in the claims and their equivalents. Further, such embodiments can also be implemented together in combination. For example, in the embodiments described above, the order of the operations and the order of the processes are shown as examples, and are not limited thereto. The same applies to cases in which numerical values or mathematical expressions are used in the description of the aforementioned embodiments.

1. A work vehicle including vehicle wheels and a working member, the work vehicle comprising:
a first control unit configured to control rotation of the working member based on a target working member rotation state amount; and
a second control unit configured to control movement of the work vehicle based on a target vehicle movement state amount,
wherein the target working member rotation state amount:
is instructed by a passenger of the work vehicle;
is instructed by an operator of the work vehicle;
is instructed by a manager of the work vehicle;
is determined by the work vehicle; or
is determined by a control device that is provided so as to be communicable with the work vehicle, and
the target vehicle movement state amount:
is instructed by the passenger;
is instructed by the operator;
is instructed by the manager;
is determined by the work vehicle; or
is determined by the control device.

2. The work vehicle according to claim 1, wherein:
a control mode in which the rotation of the working member is controlled by the first control unit includes a first working member control mode of controlling the rotation of the working member based on the target working member rotation state amount, and a second working member control mode of controlling the rotation of the working member based on a reduced target working member rotation state amount that is smaller than the target working member rotation state amount; and
during the first working member control mode, in a case that an output correlation value in the working member, or an output correlation value in a drive source configured to drive the working member has become less than a predetermined first threshold value, the first control unit transitions from the first working member control mode to the second working member control mode.

3. The work vehicle according to claim 2, wherein
during the first working member control mode, in a case that the output correlation value has become less than the first threshold value for a predetermined second threshold time period or more, the first control unit transitions from the first working member control mode to the second working member control mode.

4. The work vehicle according to claim 2, wherein
during the second working member control mode, in a case that the output correlation value has become greater than or equal to a predetermined third threshold value that differs from the first threshold value, the first control unit transitions from the second working member control mode to the first working member control mode.

5. The work vehicle according to claim 4, wherein
during the second working member control mode, in a case that the output correlation value has become greater than or equal to the third threshold value for a predetermined fourth threshold time period or more, the first control unit transitions from the second working member control mode to the first working member control mode.

6. The work vehicle according to claim 1, wherein:
a control mode in which the rotation of the working member is controlled by the first control unit includes a first working member control mode of controlling the rotation of the working member based on the target working member rotation state amount, and a second working member control mode of controlling the rotation of the working member based on a reduced target working member rotation state amount that is smaller than the target working member rotation state amount; and
during the first working member control mode, in a case that a movement state amount of the work vehicle has become less than a predetermined fifth threshold value, the first control unit transitions from the first working member control mode to the second working member control mode.

7. The work vehicle according to claim 6, wherein
during the first working member control mode, in a case that the movement state amount has become less than the fifth threshold value for a predetermined sixth threshold time period or more, the first control unit transitions from the first working member control mode to the second working member control mode.

8. The work vehicle according to claim 6, wherein
during the second working member control mode, in a case that the movement state amount has become greater than or equal to a predetermined seventh threshold value that differs from the fifth threshold value, the first control unit transitions from the second working member control mode to the first working member control mode.

9. The work vehicle according to claim 8, wherein
during the second working member control mode, in a case that the movement state amount has become greater than or equal to the seventh threshold value for a predetermined eighth threshold time period or more, the first control unit transitions from the second working member control mode to the first working member control mode.

10. The work vehicle according to claim 2, wherein
when transitioning from the first working member control mode to the second working member control mode, the first control unit controls the rotation of the working member in a manner so that a change occurs, by a first amount of change, from the target working member rotation state amount to the reduced target working member rotation state amount.

11. The work vehicle according to claim 10, wherein
when transitioning from the second working member control mode to the first working member control mode, the first control unit controls the rotation of the working member in a manner so that a change occurs, by a second amount of change that differs from the first amount of change, from the reduced target working member rotation state amount to the target working member rotation state amount.

12. The work vehicle according to claim 11, wherein
a magnitude of the second amount of change is greater than a magnitude of the first amount of change.

13. The work vehicle according to claim 1, wherein:
a control mode in which the movement of the work vehicle is controlled by the second control unit includes a first movement control mode of controlling the movement of the work vehicle based on the target vehicle movement state amount, and a second movement control mode of controlling the movement of the work vehicle based on a first reduced target vehicle movement state amount that is smaller than the target vehicle movement state amount; and
during the first movement control mode, in a case that an output correlation value in the working member, or an output correlation value in a drive source configured to drive the working member has become greater than or equal to a predetermined ninth threshold value, the second control unit transitions from the first movement control mode to the second movement control mode.

14. The work vehicle according to claim 13, wherein
during the first movement control mode, in a case that the output correlation value has become greater than or equal to the ninth threshold value for a predetermined tenth threshold time period or more, the second control unit transitions from the first movement control mode to the second movement control mode.

15. The work vehicle according to claim 14, wherein
during the second movement control mode, in a case that the output correlation value has become less than a predetermined eleventh threshold value that differs from the ninth threshold value, the second control unit transitions from the second movement control mode to the first movement control mode.

16. The work vehicle according to claim 15, wherein
during the second movement control mode, in a case that the output correlation value has become less than the eleventh threshold value for a predetermined twelfth threshold time period or more, the second control unit transitions from the second movement control mode to the first movement control mode.

17. The work vehicle according to claim 13, wherein:
a control mode in which the movement of the work vehicle is controlled by the second control unit further includes a third movement control mode of controlling the movement of the work vehicle based on a second reduced target vehicle movement state amount that is smaller than the first reduced target vehicle movement state amount; and
during the second movement control mode, in a case that the output correlation value has become greater than or equal to a predetermined thirteenth threshold value that is greater than the ninth threshold value, the second control unit transitions from the second movement control mode to the third movement control mode.

18. The work vehicle according to claim 17, wherein
during the second movement control mode, in a case that the output correlation value has become greater than or equal to the thirteenth threshold value for a predetermined fourteenth threshold time period or more, the second control unit transitions from the second movement control mode to the third movement control mode.

19. The work vehicle according to claim 17, wherein
during the third movement control mode, in a case that the output correlation value has become less than a predetermined fifteenth threshold value that differs from the thirteenth threshold value, the second control unit transitions from the third movement control mode to the second movement control mode.

20. The work vehicle according to claim 19, wherein
during the third movement control mode, in a case that the output correlation value has become less than the fifteenth threshold value for a predetermined sixteenth threshold time period or more, the second control unit transitions from the third movement control mode to the second movement control mode.

21. The work vehicle according to claim 13, wherein:
a control mode in which the movement of the work vehicle is controlled by the second control unit further includes a third movement control mode of controlling the movement of the work vehicle based on a second reduced target vehicle movement state amount that is smaller than the first reduced target vehicle movement state amount; and
during the first movement control mode, in a case that the output correlation value has become greater than or equal to a predetermined seventeenth threshold value that is greater than the ninth threshold value, the second control unit transitions from the first movement control mode to the third movement control mode.

22. The work vehicle according to claim 21, wherein
during the third movement control mode, in a case that the output correlation value has become less than a predetermined fifteenth threshold value for a predetermined sixteenth threshold time period or more, the second control unit transitions from the third movement control mode to the second movement control mode.

23. The work vehicle according to claim 13, wherein
when transitioning from the first movement control mode to the second movement control mode, the second control unit controls the movement of the work vehicle in a manner so that a change occurs, by a third amount of change, from the target vehicle movement state amount to the first reduced target vehicle movement state amount.

24. The work vehicle according to claim 23, wherein
when transitioning from the second movement control mode to the first movement control mode, the second control unit controls the movement of the work vehicle in a manner so that a change occurs, by a fourth amount of change that differs from the third amount of change, from the first reduced target vehicle movement state amount to the target vehicle movement state amount.

25. The work vehicle according to claim 24, wherein
a magnitude of the third amount of change is greater than a magnitude of the fourth amount of change.

26. An information processing device configured to control a work vehicle including vehicle wheels and a working member, the information processing device comprising:
a first control unit configured to control rotation of the working member based on a target working member rotation state amount; and
a second control unit configured to control movement of the work vehicle based on a target vehicle movement state amount, wherein the target working member rotation state amount:
is instructed by a passenger of the work vehicle;
is instructed by an operator of the work vehicle;
is instructed by a manager of the work vehicle;
is determined by the work vehicle; or
is determined by a control device that is provided so as to be communicable with the work vehicle, and
the target vehicle movement state amount:
is instructed by the passenger;
is instructed by the operator;
is instructed by the manager;
is determined by the work vehicle; or
is determined by the control device.

27. A control method for controlling a work vehicle including vehicle wheels and a working member, the control method comprising:
controlling rotation of the working member based on a target working member rotation state amount; and
controlling movement of the work vehicle based on a target vehicle movement state amount,
wherein the target working member rotation state amount:
is instructed by a passenger of the work vehicle;
is instructed by an operator of the work vehicle;
is instructed by a manager of the work vehicle;
is determined by the work vehicle; or
is determined by a control device that is provided so as to be communicable with the work vehicle, and
the target vehicle movement state amount:
is instructed by the passenger;
is instructed by the operator;
is instructed by the manager;
is determined by the work vehicle; or
is determined by the control device.

28. A non-transitory computer-readable storage medium configured to store a program for causing a computer to execute the control method according to claim 27.
